(19) United States
(12) Patent Application Publication
(10) Pub. No.: US 2023/0270124 A1
(43) Pub. Date: Aug. 31, 2023

(54) EDIBLE FOOD CASING

(71) Applicant: ALZARRO DÖNERWORLD GMBH, Korbußen (DE)

(72) Inventor: Mustafa Demirkürek, Gera (DE)

(21) Appl. No.: 17/924,095

(22) PCT Filed: May 10, 2021
(86) PCT No.: PCT/EP2021/062321

§ 371 Date: Nov. 8, 2022

(30) Foreign Application Priority Data
May 15, 2020 (DE) 20 2020 102 778.6

(51) Int. Cl. A21D 13/31; A23L 19/00; A23P 20/20

(52) U.S. Cl. CPC A21D 13/31; A23L 19/05; A23P 20/20

(57) ABSTRACT

The invention relates to an edible food casing based on leavened dough, consisting of two pieces of dough rolled out into a circular shape, a first piece of dough forming a rest for certain foodstuffs, and the second piece of dough being arranged over the deposited amount, a closure being produced between the first and second pieces of dough via the edge region, and the pieces of dough being subjected to a baking temperature treatment to harden the casing and the closure.

The invention relates to an edible food casing based on yeast dough, consisting of at least two pieces of dough rolled out into a round shape.

A bakery product, in particular a bread roll for a fast food unit, is previously known from DE 44 28 504 A1.

The bakery product is used to accommodate a meat, fish, sausage or cheese filling or another such food filling.

The bakery product has a recess, which is delimited by an inner contour and is produced during the baking process. The recess is matched to the dimensions of the food filling to be accommodated in the bakery product.

The bakery product can be in the form of a half shell or can be half-shell-shaped. In addition, the bakery product can have a flat edge surface or an edge surface with a stepped profile. The bakery product is accordingly a thermal insulator and a protector of the contents thereof, so that the consumer can consume the fast food unit without getting dirty.

Utility model DE 203 04 477 U1 also discloses a bakery product with a body which is covered with a first crust on the outside and has a pocket. The pocket has at least one delimiting wall, which is formed by a second crust.

The delimiting wall lends the known bakery product greater bite resistance, which means that the consumer has the sensation of something between their teeth when biting into the bakery product. Specifically, the crust delimiting the pocket in the interior of the bakery product forms a layer which the user's teeth must penetrate during biting.

In one embodiment, the first and second crusts merge into one another. This is advantageous when the pocket is filled. The body of the known bakery product is formed from bread dough, which ensures a sufficient crust during the baking process.

Also known are flat cakes or doner pockets, which can be filled with chicken breast fillet, salads, cucumber or the like, for example.

The bakery product for accommodating food according to DE 20 2016 102 032 U1 proceeds from a baked body which has a cavity-like inner contour which surrounds the food. A mixture of cooled doner meat, salad ingredients and a sauce combination is used as the food, that is, the filling for the bakery product. The baked product body is intended to surround the food mixture completely on all sides.

The closed casing makes it possible for the bakery product to be transported easily without the food contained in the interior of the baked product body being able to escape.

However, it has been found that the described prior art examples are complex to prepare or that there is a risk of liquid or moisture-containing components of the accommodated food penetrating the wall of the bakery products. Firstly, this is problematic when transporting the product. Secondly, however, the handling and consumption of a partially soaked bakery product is associated with an unpleasant sensation, which should be avoided.

Proceeding from that mentioned above, the object of the invention is to specify a further developed edible food casing based on yeast dough which avoids the described disadvantages, is inexpensive to produce, and can also form the basis for a frozen product.

The object of the invention is achieved by an edible food casing based on yeast dough according to the combination of features in claim 1; the dependent claims describe at least expedient embodiments and developments.

Accordingly, the invention proceeds from an edible food casing based on yeast dough. The food casing consists of at least two pieces of dough rolled out into a round shape.

A first piece of dough forms a base for a mixture of red cabbage, white cabbage, lettuce, pieces of tomato, onions and, where necessary, further vegetarian ingredients. Furthermore, the first piece of dough forms a base for a cooked or grilled, that is, edible piece of meat. This can be veal, chicken or the like.

Furthermore, the first piece of dough accommodates an amount of preprepared herb sauce, while an edge region of the first piece of dough remains uncovered.

The second piece of dough is arranged over the amount of topping, and a closure is formed between the first and second pieces of dough via the edge region.

To stabilise the casing and the closure, the food casing is subjected to treatment at baking temperature.

The dough used consists substantially of the ingredients flour, salt, yeast, oil, milk and added water.

Usually, the prepared dough is left for a rest time. Balls are then formed from the dough and rolled out mechanically or manually to form the pieces of dough. This is followed by a further rest time for the rolled-out pieces of dough of between 15 and 20 minutes, for example.

The herb sauce used contains, as essential components, milk, yoghurt, mayonnaise, sugar, salt, salad herbs, dill, basil, oil, in particular olive oil, and chopped parsley.

The second piece of dough can be wetted with the prepared herb sauce.

At least in the first piece of dough, a concave region is formed by treating the raw dough in order to fix the amount of topping in place and to ensure that an edge region remains uncovered.

The pieces of dough are preferably circular with a diameter within the range of 5-15 cm.

As mentioned, the dough and thus the pieces of dough contain oil, in particular a vegetable oil, in this case again in particular olive oil.

The mixture of the coating can be prepared freshly as raw coleslaw in order to preserve valuable vitamins.

The mixture can additionally contain fresh cucumber or pickled gherkins.

The topping deposited onto the first piece of dough can also be sprinkled with herb salt.

The recipe for a unit of the edible food casing with topping is mentioned by way of example below:

| Ingredient | Amount |
|---|---|
| Meat (veal) | 100 g |
| Dough | 100 g |
| Sauce (herb) | 100 g |
| Iceberg lettuce | 20 g |
| Onion | 15 g |
| Red cabbage | 15 g |
| White cabbage | 15 g |

Instead of the edibly prepared piece of meat for the topping, a vegan substitute, for example consisting of soya, can be used so that very different markets can be served with the product according to the invention. The casing, which is firm and stable thanks to the baking, protects the food in the interior from dirt and preserves valuable constituents such as vitamins, trace elements and the like.

After the baking process, the fully baked product can be quick-frozen and marketed as a frozen product.

Adaptations to different demands and consumption habits can easily be made by means of different sizes of the food casing with correspondingly adapted topping or filling.

1. An edible food casing based on yeast dough, consisting of two pieces of dough rolled out into a round shape, wherein a first of the pieces of dough forms a base for a mixture of red cabbage, white cabbage, lettuce, pieces of tomato and onions and for a cooked or grilled piece of meat, the first piece of dough furthermore accommodates an amount of herb sauce, wherein an edge region of the first piece of dough remains uncovered, the second piece of dough is arranged over the amount of topping, and a closure is formed between the first and second pieces of dough via the edge region, and a treatment at baking temperature is carried out in order to stabilise the casing and the closure.

2. The edible food casing according to claim 1,
characterised in that
the second piece of dough is wetted with herb sauce.

3. The edible food casing according to claim 1 or 2,
characterised in that
a concave region is provided at least in the first piece of dough.

4. The edible food casing according to claim 1,
characterised in that
the pieces of dough are circular and have a diameter within the range of 5-15 cm.

5. The edible food casing according to claim 1,
characterised in that
the herb sauce consists of a mixture containing at least milk, yoghurt, mayonnaise, sugar, salt, salad herbs, dill, basil, vegetable oil and parsley.

6. The edible food casing according to claim 1,
characterised in that
the pieces of dough contain oil.

7. The edible food mixture according to claim 1,
characterised in that
the mixture contains a raw coleslaw.

8. The edible food casing according to claim 1,
characterised in that
The mixture contains cucumber.

9. The edible food casing according to claim 1,
characterised in that
the topping is sprinkled with herb salt.
